(19) United States
(12) Patent Application Publication
(10) Pub. No.: US 2004/0249044 A1
(43) Pub. Date: Dec. 9, 2004

(54) High temperature resistant coating composition

(76) Inventors: Tuan Nguyenquang, Sunnyvale, CA (US); Rong Jong Chang, Fremont, CA (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/782,393

(22) Filed: Feb. 18, 2004

Related U.S. Application Data
(60) Provisional application No. 60/448,657, filed on Feb. 18, 2003.

(51) Int. Cl. C08K 3/08; C08K 3/18; C08K 3/34

(52) U.S. Cl. 524/430; 524/441; 524/449

(57) ABSTRACT

A high temperature resistant coating composition comprising mainly a silicone resin, an epoxy resin, an amidoamine curing agent, and a mixture of three fillers: titanium dioxide, aluminum flake, and micaceous iron oxide. The silicone resin based composition can resist greater than 500° C. temperature for long term uses and can protect a kiln or industrial facilities such as a cement or power plant from corrosions, including undercut corrosions, and chemical attacks, particularly sodium hydroxide. The coating can gel at ambient temperature to render it tack free for easy handling and inspection. The composition disclosed herein has improved coating properties and can be baked at elevated temperatures without sagging or run-off on a vertical surface. Optionally, additional fillers, a catalyst, an additive, and an organic solvent can be added to the composition.

### CROSS-REFERENCE TO RELATED APPLICATIONS

This application claims priority from a provisional patent application No. 60/448,657, filed Feb. 18, 2003, the content of which is incorporated herein by reference.

### FIELD OF THE INVENTION

The invention generally relates to a high temperature resistant coating composition. More particularly, it relates to a composition comprising mainly a mixture of a silicone resin (A), an epoxy resin (B), an amine curing agent (C), and a combination of fillers (D), which can be cured at ambient temperature to render it a tack free surface. After subsequent heat cure, the coating exhibits good film properties, high temperature resistance and undercut corrosion resistance.

### DESCRIPTION OF THE BACKGROUND ART

Over the past 50 years, silicone resins have increasingly been used in the high temperature coatings. Listed below are several overview papers that provide a good introduction of the technology and an excellent summary of the background arts. The respective content of these papers is incorporated herein by reference.

1. Clive H. Hare, “Silicone Resins,” JPCL (Journal of Protective Coatings and Linings), January 1995, pp. 79-103.

2. William A. Finzel, “Properties of High Temperature Silicone Coatings, JPCL, August 1987, pp. 38-43.

3. William A. Finzel, “Silicone Coatings, Generic Coating Types,” JPCL, August 1995, pp. 93-106.

As described in the aforementioned references, the high temperature resistance of silicone resins has been attributed to its silicon-oxygen backbone in contrast with the carbon-carbon backbone for most organic polymers. A coating based on 100% silicone resin can resist up to 371° C. To achieve an even higher temperature performance, a platelet type of inorganic or metallic filler such as mica or aluminum flake is added to form a thermal reflective layer, and some filled silicone resin coatings can resist as high as 638° C. (1200° F.).

However, silicone resin based coatings for high temperature applications still suffer from several shortcomings. First, silicone resin is susceptible to chemical attack, particularly by sodium hydroxide, and if aluminum flake is used to raise the temperature performance, it reduces acid resistance of the coating. Second, a silicone resin based coating requires high temperature baking above 200° C. to achieve the desired heat resistance properties. The coating can sag and run off during the heating process and thus leads to uneven or defective coating. Third, the silicone resin based coating is brittle and susceptible to cracking and lifting especially under thermal stress. This problem is particularly severe if the coating has poor adhesion or when its thickness is greater than three mils. Fourth, due to its inorganic nature, the coating properties such as gloss, impact resistance, toughness, or abrasion resistance are poor compared with most organic based coatings. Last, they have poor resistance to undercut corrosion, i.e., when there is pit corrosion developed due to imperfection in the coating, it quickly propagates underneath the coating.

To address some of the aforementioned shortcomings, one can modify silicone resin with organic components. The modification can be achieved by simply blending an organic resin with the silicone resins or by direct substitution of an reactive organic functionality onto the silicone resins, as described by Keijman, “The Use of Novel Siloxane Hybrid Polymers in Protective Coatings,” PCE (Protective Coatings Europe), July 1996, pp. 26-32. Examples of chemically substituted silicone resins are Silikoftal® ED and Silikofal® EW, both of which are epoxy functionalized silicone resins supplied by Tego Chemie. The epoxy functionality allows ambient curing when a suitable curing agent such as an amine is added to the composition to pre-cure the coating and thus prevents the coating from sagging or run-off during the subsequent baking at elevated temperatures.

By adding the organic content, the film forming properties and crack resistance are also improved. However, the increasing of organic content either by blending or functionalization normally compromises the heating resistance. The heat resistance of most organic modified silicone resin coatings is limited to 232° C.-371° C., as noted in the Reference 2 cited above.

Thus, the challenge for the application of the silicone resin based coatings has been how to improve the film forming properties without sacrificing heat resistance. Muis disclosed in U.S. Pat. No. 4,190,686 a composition comprising a ceramic glaze material, a thermosetting phenolic resin, an organic paint resin such as epoxy, polyester or acrylic and a silicone resin as leveling agent. The coating was either for protection steel from corrosion and chemical attack or for protection of wood from fire. There was no mention of heat resistance; however, as it would have been apparent to any person skilled in the art, Muis's composition is unlikely to be suitable for a long-term exposure at temperatures greater than 200° C.

Arai disclosed in U.S. Pat. No. 4,374,754 a self-cleaning coating composition containing a silicone resin, an organic solvent, an oxidation catalyst such as manganese oxide and/or platinum or palladium. The composition was designed to catalytically oxidize and remove fats and oils on interior surfaces of an oven, and it was claimed to resist temperature up to 600° C.

Matsumoto et al. disclosed in U.S. Pat. No.'s 4,657,963 and 4,746,568 compositions consisting of a modified silicone resin, an aluminum chelate compound such as ethyl acetate aluminum diisopropylate, an organic resin, and a mixture of pulverized inorganic materials for use in coating exhaust pipes of motorcars. The compositions showed good film forming properties and corrosion protection without compromising heat resistance.

Eklund et al. disclosed in U.S. Pat. No. 6,180,726 a high temperature resistant powder coating composition comprising a resin containing functional hydroxyl groups, a polyfunctional epoxy resin, and an anhydride compound. The composition was claimed to withstand high temperature up to 300° C.

The prior patents cited above addressed some but not all of the aforementioned shortcomings of silicone resin based coatings. Therefore, there remains a need in the art for a high temperature resistant coating composition that overcomes all drawbacks of the prior arts.

### SUMMARY OF THE INVENTION

Accordingly, it is the primary object of the present invention to provide an improved silicone resin based coating which can resist greater than 500° C. temperature for long term uses.

It is another object of the present invention to provide an improved silicone resin based coating that can gel at ambient temperature to render it tack free for easy handling and inspection.

It is a further object of the present invention to provide an improved silicone resin based coating that can be baked at elevated temperatures without sagging or run-off on a vertical surface.

It is another object of the present invention to provide a silicone resin based coating that has improved coating properties.

It is still another object of the present invention to provide a silicone resin based coating with improved chemical resistance, particularly to sodium hydroxide.

It is yet another object of the present invention to provide a silicone resin based coating with improved resistance to undercut corrosion.

These objectives are achieved in a novel and inventive high temperature resistant coating composition comprising mainly a silicone resin, an epoxy resin, an amidoamine curing agent, and a mixture of three fillers: titanium dioxide, aluminum flake, and micaceous iron oxide that met all objects desired. The composition is particularly useful for protecting a kiln or baghouse in industrial facilities, such as a cement or power plant, from corrosion and chemical attack.

### DESCRIPTION OF THE INVENTION

According to the present invention, the high temperature resistant coating composition consists of the following ingredients and their mass percentages. The total mass percentage of all ingredients must be 100%.

| | Ingredient | Mass % |
|---|---|---|
| A | Silicone resin (without solvent) | 10-17.5 |
| B | Epoxy resin | 3-15 |
| C | Epoxy curing agent | 6-30 |
| D | Fillers | |
| | (1) Aluminum flake | 1-10 |
| | (2) Titanium dioxide | 35-45 |
| | (3) Micaceous iron oxide | 7-20 |
| | (4) Others (optional) | 0-10 |
| B | Catalyst (optional) | 0-1 |
| F | Additive (optional) | 0-5 |
| G | Solvent (optional) | 0-7 |
| | Total | 100.00 |

The Component A, silicone resins, can be a straight or modified resin. In actual production, silicone resin may contain a certain amount of solvent, e.g., 20-35 mass parts of silicone resin with 50% in xylene. As one skilled in the art will appreciate, any amount of solvent may be used in actual production and is not limited to a 50% solution. The straight silicone resin has a general formula of:

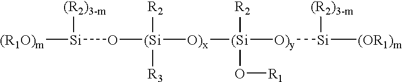

where R₁=either H, or CH₃, or C₂H₅,

R₂=an alkyl, acyclic, or aryl, preferably CH₃ or Phenyl (—C₆H₅),

R₃=an alkyl, acyclic, or aryl, preferably CH₃ or Phenyl (—C₆H₅),

R₂=R₃ or R₂≠R₃, and

m=1-3, preferably 2, most preferably 3.

The combination of x and y determines the molecular weight of the resin, and either x or y can be from 1 up to several thousands. The ratio or y/x determines the cross-linking density of the final bake coating, and it can be from 20 for a high density network to 0.05 for a low density network. Preferably (x+y) and y/x of the resin are low enough so that the resin is a liquid by itself, or can be dissolved in an organic solvent to form a liquid solution so that the final coating can be toweled, brushed, or sprayed.

In the modified silicone resin, from 1% to 30% of R₂ is replaced with a reactive functional group such as epoxy, amine, vinyl, hydride, acrylic, anhydride, carboxylic, etc.

The silicone resins useful for the present invention can be a mixture of many straight silicon resins, or a mixture of straight silicone resins with up to 49% of modified silicone resins.

The Component B, epoxy resin, can be any bisphenol A diglycidyl ether, bisphenol F diglycidyl ether, phenolic epoxy, phenol novolac epoxy, cresol novolac epoxy, tris(hydroxylphenyl) methane triglycidylether, triglycidyl p-aminophenol, tetraglycidyl amine of methylenedianiline, 1,3,5-tris(2,3-epoxypropyl)-1,3,5-perhydrotriazine-2,4,6-trione (triglycidyl isocyanurate), polyglycidylether of poly(4-hydroxylstyrene), etc. It is preferable that B-1 be in a liquid form. If it is in solid form, a suitable solvent may be added to prepare a liquid solution. It is also understood that B-1 can be a mixture of various epoxy resins mentioned above. It is preferable that the epoxy resin is a novolac epoxy due to its low viscosity and good chemical resistance.

The Component C is an amine curing agent or a mixture of amine curing agents for the Component B (epoxy resin). The curing agents include aliphatic amines, amidoamines, and cycloaliphatic amines. It is preferable to use amidoamines since they provide better adhesion to metal and also adequate pot life for the formulations. It is preferable that a stoichiometry amount of curing agent be used to react with the epoxy resin. However, a deviation of 15% from the stoichiometry amount will not significantly affect the coating properties of the present invention.

The Component D is a mixture of fillers of mainly three fillers: aluminum flake, titanium dioxide, and micaceous oxide. Aluminum flake can be leafing or non-leafing type, preferably a non-leafing type. It can be in solid form or pre-dispersed in a paste form. Titanium dioxide can be anatase or rutile type, preferably rutile type. Micaceous iron oxide refers to a crystalline form of iron oxide which naturally occurring in pallet form, which is very different from the more familiar red, yellow, and brown form of iron oxides. Optionally, other fillers such as mica, glass flakes, etc. can be added in small amount without significantly deteriorate the coating properties of the present invention.

The Component E is a catalyst optionally added to promote cross-linking reaction of silicone resin during high temperature bake. Most metallic organic salts such as zirconium octoate, cobalt octoate, zinc octoate, iron octoate, stannous octoate, or a commercial catalyst, such as K-Kat 348 supplied by King Industries, can be used. There are many known catalysts and any person skilled in the art will have no problem choosing such a catalyst.

The Component F is additional additive(s) such as wetting agent, dispersing agent, deflocculating agent, thixotropic agent, defoaming agent, leveling agent, colorant, coupling agent, etc., that can be added to help dispersing of fillers, preventing filler settling, and improving film forming properties or appearance.

The Component G is an organic solvent, optionally added to reduce viscosity of the mixture to facilitate coating application such as air spray or airless spray. The amount of solvent should be kept at a minimum, e.g., below 3.5 pounds per gallon of coating, preferably below 2.8 pounds per gallon, and most preferably below 1.8 pounds per gallon to reduce environmental pollution. Organic solvent selected must be compatible with silicone and epoxy resins. Toluene or xylene is often used with silicone resins.

To prepare the coating, a laboratory high speed disperser is used. Weigh titanium dioxide in a one-liter stainless container, and add silicone resin and epoxy resin. Let the mixture sit for 30 minutes. This will allow resins to soak into titanium dioxide. Mix the mixture with the high speed disperser at 4000 rpm and move the mixing blade up and down if necessary until the mixture is well dispersed. The mixture should achieve a reading of 7 or higher on the Hegman dispersion gauge. This process should take about 15-30 minutes. Add micaceous iron oxide and continue to mix at 4000 rpm for another 15-20 minutes until the mixture achieve a reading of 6 or higher on the Hegman gauge. Reduce the speed to 400 rpm and gently blend aluminum flake to the mixture. Close the lid of the container and let the whole mixture soak overnight (about 12-16 hours). Next, stir the mixture at 800 rpm for 15 minutes. Add solvent to obtain the Part A of the composition. Keep amine curing agent (Component C) separate as Part B of the composition. Part A and Part B are to be mixed just prior to coating application.

The following example shows a high temperature resistant coating composition prepared according to an embodiment of the present invention. EXAMPLE 1

| | Ingredient | Description | Mass % |
|---|---|---|---|
| A | Silikophen P50/X | Silicone resin (50% in xylene) | 25.96 |
| | (Tego Chemie) | | |
| B | Epalloy 8230 | Novolac Epoxy | 6.49 |
| | (CVC Specialty Chemicals) | | |
| C | Ancamide 2353 | Polyamidoamine curing agent | 13.41 |
| | (Air Products) | | |
| D | Fillers | | |
| | (1) DF-L 520 AR | Aluminum flake | 5.19 |
| | (Silberline) | | |
| | (2) Tiona RCL-9 | Titanium dioxide | 42.18 |
| | (Millenium) | | |
| | (3) Nubifer EF | Micaceous iron oxide | 13.32 |
| | (Nubiola) | | |
| G | Xylene | Solvent | 3.37 |
| | | Total | 100.00 |

The high temperature resistant coating composition so prepared, applied in a 5-mil single layer on a steel panel (Q-Panel), became tack-free within 12 hours at room temperature. The coated panel was then cured at 250° C. in a vertical position for one hour and no sagging or run-off was observed. After baking, the coated panel was quickly brought out of the oven and cooled down to ambient temperature. No delamination was observed during the thermal contraction. The baked coating showed high gloss and exhibited good scratch resistance.

The chemical resistance was tested by ASTM D471 by immersing a coating film in each of the test chemical for one week, and % weight gain was measured. It showed the weight gain in water, 36% sulfuric acid, 54% phosphoric acid, and 50% sodium hydroxide was 0.8%, 1.1%, 1.2%, and 2.5%, respectively.

The baked coatings films were then subjected to long term heat aging at 250° C., 325° C., and 550° C. The baked films were taken out of the heating aging ovens weekly to simulate thermal cycling. The coatings resisted 325° C. and 550° C. up to three months without significant change in film properties and showed no cracking due to thermal cycling.

A baked film coated on a sand-blasted Q-Panel was also scribed and subjected to outdoor exposure with periodic spray of sodium chloride solution for two months according to ASTM D6675. The coating had very good resistance to undercut corrosion, having less than 0.5 mm ingress of corrosion from the scribed line in one month. The adhesion of the coating remained good after the outdoor aging.

This working example demonstrated that the composition prepared according to the present invention is suitable for use in many applications as a high temperature resistant coating to protect steel from corrosion and chemical attack.

### COMPARATIVE EXAMPLE 1

Instead of using a physical blend of epoxy resin with straight silicone resin, this comparative example was formulated with an epoxy modified silicone resin, in which the epoxy functional group was chemically attached to the silicone resin.

| | Ingredient | Description | Mass % |
|---|---|---|---|
| A | Silikoftal ED | Epoxy modified silocone resin | 34.92 |
| | (Tego Chemie) | | |
| C | Ancamine 2089M | Modified Polyamine curing agent | 5.82 |
| D | Fillers | | |
| | (1) Tiona RCL-9 | Rutile titanium oxide | 45.04 |
| | (Millenium) | | |
| | (2) Mica 20E | Muscovite mica | 14.32 |
| | (Fibertec) | | |
| | | Total | 100.00 |

A coating prepared according to the above formulation was applied onto a Q-Panel the same way as described in Example 1. The coating gelled and became tack free in 12 hours, and it was then baked in a vertical position at 250° C. for one hour.

The baked coating films were then subjected to long term heat aging at 250° C., 325° C., and 550° C. The baked films were taken out of the heating aging ovens weekly to simulate thermal cycling. The coatings resisted 250° C. aging for one week without cracking and delaminating, but at 325° C. and 550° C. they became powdery and eventually mud-cracked in three days. This demonstrated that, unlike the present invention as shown in Example 1, the coating based on the epoxy modified silicone resin is not suitable for applications of temperature higher than 250° C.

### COMPARATIVE EXAMPLE 2

A commercial silicone resin based coating was also selected for comparison with the present invention. The following formulation was recommended by GE Silicones in its technical data sheet, which is included herein by reference.

| | Ingredient | Description | Mass % |
|---|---|---|---|
| A | (1)Triplus 179 | Methyl silsesquioxane | 22.09 |
| | | resin | |
| | (2)Triplus 178 | Polydimethylsiloxane | 18.07 |
| | (GE Silicones) | | |
| D | Fillers | | |
| | (1) Tiona RCL-9 | Titanium oxide | 45.38 |
| | (Millenium) | | |
| | (2) Mica 20E | Muscovite mica | 14.46 |
| | (Fibertec) | | |
| E | K-Kat 348 | Catalyst | 0.004 |
| | (King Industries) | | |
| | | Total | 100.00 |

A coating prepared according to the above formulation was applied onto a Q-Panel the same way as described in Example 1. The coating did not cure at ambient temperature and it sagged when applied on a vertical surface. Thus, the Q-Panel was placed in a horizontal position and baked at 250° C. for one hour. The baked coating had a slightly powdery surface and the coating properties were not as good as that of Example 1.

The baked coating films were then subjected to long term heat aging at 250° C., 325° C., and 550° C. The coatings were taken out of the heat aging ovens daily in the first week and weekly afterwards to simulate thermal cycling. The coatings resisted 250° C. aging for 3 months without cracking or delaminating. However, the baked films appear powdery and the thickness should be kept below 2 mils to avoid cracking. At 325° C. and 550° C., the coatings delaminated and cracked as soon as they were taken out of the ovens after one day. This demonstrated that the coating based on the blend of silicone resins is not suitable for applications of temperature higher than 250° C. and therefore is substantially less versatile and useful than the present invention as shown in Example 1.

### COMPARATIVE EXAMPLE 3 (SP7.A1)

This comparative example is to demonstrate the effect of the filler package.

| | Ingredient | Description | Mass % |
|---|---|---|---|
| A | Silikophen P50/X | Phenyl methyl polysiloxane | 26.95 |
| | | resin (50% in xylene) | (Tego Chemie) |
| B | Epalloy 8230 | Phenol Novolac epoxy | 6.74 |
| | (CVC Specialty | | |
| | Chemicals) | | |
| C | Ancamide 2353 | Modified polyamide | 3.61 |
| | (Air Products) | curing agent | |
| D | Fillers | | |
| | (1) Tiona RCL-9 | Rutile titanium dioxide | 44.99 |
| | (Millenium) | | |
| | (2) Mica 20E | Muscovite mica | 14.21 |
| | (Fibertec) | | |
| G | Xylene | Solvent | 3.50 |
| | | Total | 100.00 |

A coating prepared according to the above formulation was applied onto a Q-Panel the same way as described in Example 1. The coating gelled and became tack free in 12 hours. It was then baked at 250° C. for one hour.

The baked films were then subjected to long term heat aging at 250° C., 325° C., and 550° C. The coatings were taken out of the heating aging ovens daily in the first week and weekly afterwards to simulate thermal cycling. The coatings resisted 250° C. and 325° C. aging for three months without cracking and delaminating. However, the baked films appear powdery and the thickness should be kept below 2 mils to avoid cracking. At 550° C., the coatings delaminated and cracked as soon as they were taken out of the ovens after one day. This demonstrated that the coating based on the blend of silicone resins is not suitable for applications of temperature higher than 250° C. and therefore is substantially less versatile and useful than the present invention as shown in Example 1.

### COMPARATIVE EXAMPLE 4

This comparative example offers yet another demonstration of the filler effect.

| | Ingredient | Description | Mass % |
|---|---|---|---|
| A | Silikophen P50/X | Phenyl methyl polysiloxane | 28.00 |
| | | resin (50% in xylene) | (Tego Chemie) |
| B | Epalloy 8230 | Phenol Novolac epoxy | 7.00 |
| | (CVC Specialty | | |
| | Chemicals) | | |
| C | Ancamide 2353 | Modified polyamide | 3.76 |
| | (Air Products) | curing agent | |
| D | Fillers | | |
| | (1) Tiona RCL-9 | Rutile titanium dioxide | 37.40 |
| | (Millenium) | | |
| | (2) Mica 20E | Muscovite mica | 11.81 |
| | (Fibertec) | | |
| | (3) REF-160 | Microglas glass flake | 8.40 |
| | (NGF Canada) | | |
| G | Xylene | Solvent | 3.64 |
| | | Total | 100.00 |

A coating prepared according to the above formulation was applied onto a Q-Panel the same way as described in Example 1. The coating gelled and became tack free in 12 hours, and it was then baked at 250° C. for one hour. When the baked coating was subjected to 50% sodium hydroxide, it was totally dissolved in a few days.

The baked films were then subjected to long-term heat aging at 250° C., 325° C., and 550° C. The coatings were taken out of the heating aging ovens daily in the first week and weekly afterwards to simulate thermal cycling. The coatings resisted 250° C. and 325° C. aging for three months without cracking and delaminating. However, the baked films appear powdery and the thickness should be kept below 2 mils to avoid cracking. At 550° C., the coatings delaminated and cracked as soon as they were taken out of the ovens after one day. This demonstrated that the coating based on the blend of silicone resins is not suitable for applications of temperature higher than 325° C. and therefore is substantially less versatile and useful than the present invention as shown in Example 1.

Although the present invention and its advantages have been described in detail, it should be understood that the present invention is not limited to or defined by what is shown or discussed herein. The tables, description and discussion herein illustrate technologies related to the invention, show examples of the invention and provide examples of using the invention. Known methods, procedures, systems, elements, or components may be discussed without giving details, so to avoid obscuring the principles of the invention. One skilled in the art will realize that implementations of the present invention could be made without departing from the principles, spirit, or legal scope of the present invention. Accordingly, the scope of the present invention should be determined by the following claims and their legal equivalents.

We claim:

1. A high temperature resistant coating composition having a total mass percentage of 100, said coating composition comprising:
A) a silicone resin having a mass percentage of approximately 10 to 17.5;
B) an epoxy resin having a mass percentage of approximately 3 to 15;
C) an epoxy curing agent having a mass percentage of approximately 6 to 30;
D) a filler package comprising:
(1) aluminum flake having a mass percentage of approximately 1 to 10;
(2) titanium dioxide having a mass percentage of approximately 35 to 45; and
(3) micaceous iron oxide having a mass percentage of approximately 7 to 20;
E) an optional catalyst having a mass percentage of approximately 0 to 1, said catalyst promoting hydrolysis and condensation reactions of said silicone resin;
F) an optional additive having a mass percentage of approximately 0 to 5, said additive facilitating mixing or adjusting rheology of said coating composition; and
G) an optional organic solvent having a mass percentage of approximately 0 to 7.

2. The coating composition according to claim 1, said silicone resin having a formula of: 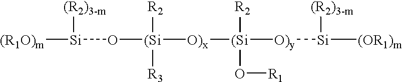
where R₁ is selected from the group consisting of H, CH₃, and C₂H₅;
R₂ is selected from the group consisting of alkyl, acyclic, aryl, CH₃, and Phenyl (—C₆H₅);
R₃ is selected from the group consisting of alkyl, acyclic, aryl, CH₃, and Phenyl (—C₆H₅);
m is an integer selected from the group consisting of 1, 2, and 3;
x and y are integers where x+y is from 2 to 6000 and y/x is from 0.05 to 20;
wherein R₂=R₃ or R₂≠R₃.

3. The coating composition according to claim 1, wherein said epoxy resin is selected from the group consisting of bisphenol A diglycidyl ether, bisphenol F diglycidyl ether, phenol novolac epoxy, cresol novolac epoxy, tris(hydroxylphenyl) methane triglycidylether, triglycidyl p-aminophenol, tetraglycidyl amine of methylenedianiline, 1,3,5-tris(2,3-epoxypropyl)-1,3,5-perhydrotriazine-2,4,6-trione (triglycidyl isocyanurate), and polyglycidylether of poly(4-hydroxylstyrene).

4. The coating composition according to claim 1, wherein said epoxy curing agent is selected from the group consisting of aliphatic amines, amidoamines, and cycloaliphatic amines.

5. The coating composition according to claim 1, wherein said aluminum flake is selected from the group consisting of leafing aluminum flakes or non-leafing aluminum flakes.

6. The coating composition according to claim 1, wherein said titanium dioxide is selected from the group consisting of rutile titanium dioxides and anatase titanium dioxides.

7. The coating composition according to claim 1, wherein said filler package optionally contains other fillers including mica, glass flakes, or a combination thereof.

8. The coating composition according to claim 1, wherein said catalyst is selected from the group consisting of zirconium octoate, cobalt octoate, zinc octoate, iron octoate, stannous octoate, or a commercial off-the-shelf catalyst.

9. The coating composition according to claim 1, wherein said additive is selected from the group consisting of a wetting agent, a dispersing agent, a deflocculating agent, a thixotropic agent, a defoaming agent, a leveling agent, colorant, a coupling agent, and a combination thereof.

10. The coating composition according to claim 1, wherein said organic solvent dissolves said silicone resin and said epoxy resin simultaneously to form a uniform mixture.

11. The coating composition according to claim 10, wherein said organic solvent is selected from the group consisting of toluene and xylene.

12. The coating composition according to claim 1, wherein said coating composition is capable of resisting chemical attacks including sodium hydroxide and of resisting high temperature of 500° C. or more.
